(19) United States
(12) Patent Application Publication
(10) Pub. No.: US 2015/0199777 A1
(43) Pub. Date: Jul. 16, 2015

(54) SYSTEM AND METHOD FOR RESTAURANT MENUING

(71) Applicant: Putnam Road Associates, Mahopac, NY (US)

(72) Inventor: David Antonio Rodriguez, Mahopac, NY (US)

(73) Assignee: Putnam Road Associates, Mahopac, NY (US)

(21) Appl. No.: 14/597,848

(22) Filed: Jan. 15, 2015

Related U.S. Application Data
(60) Provisional application No. 61/964,850, filed on Jan. 16, 2014.

(51) Int. Cl. G06Q 50/12; G06Q 10/00

(52) U.S. Cl. CPC G06Q 50/12; G06Q 10/00

(57) ABSTRACT

The present invention provides a restaurant menuing system and method. The method includes a server that includes a database. The database has a restaurant menu that includes a plurality of menu items and an image of each menu item. The system further includes a marker having a restaurant identifier associated with the restaurant menu. The system further includes a mobile electronic device. The mobile electronic device includes a scanner configured to acquire the restaurant identifier to the server. The mobile electronic device further includes a network interface configured to transmit the restaurant identifier to the server, and receive the restaurant associated with the transmitted restaurant identifier. The mobile electronic device further includes a user interface to display the received restaurant menu associated with the restaurant identifier.

### CROSS REFERENCE TO RELATED APPLICATIONS

The present application claims the benefit of U.S. Provisional Patent Application No. 61/964,850 filed Jan. 16, 2014 entitled “Restaurant menu presentation via web link,” the entire disclosure of which is hereby incorporated herein by reference.

### BACKGROUND OF THE INVENTION

Increasingly consumers possess mobile electronic devices such as smart phones, personal digital assistants, and tablet computers. Such devices allow users to shop online for retail goods and services. The online shopping model allows consumers to view items which are available on the Internet for purchase and to view images (sometimes multiple images from different perspectives and with different options) of items prior to making a purchase. This type of online shopping has revolutionized many retail industries.

The process of purchasing prepared food which is consumed upon receipt has not been impacted to the same degree as other industries by the online shopping model. Many dining establishments and restaurants provide patrons with physical restaurant menus that include brief descriptions of menu items. In some menus an image of some of the food items is provided but such descriptions and images are necessarily limited in size and detail by the constraints of a physical restaurant menu. Such restaurant menus may not provide sufficient detail to allow a patron to make an informed decision about their restaurant order.

Because of the limitations of restaurant menus most restaurant patrons are not familiar with all the menu items presented and often do not order particular menu items because the description of the particular menu item IS unfamiliar to the patron. In some cases restaurant patrons will order a menu item but receive a dish which does not have the appearance that the restaurant patron expected. Such an experience can cause frustration and a less than exceptional dining experience for the patron.

### BRIEF SUMMARY OF THE INVENTION

In accordance with a preferred embodiment the present invention provides a restaurant menuing system including a server that includes a database. The database includes a restaurant menu that has a plurality of menu items and an image associated with at least one menu item. The system further includes a marker having a restaurant identifier associated with the restaurant menu. The system further includes a mobile electronic device. The mobile electronic device has a scanner configured to acquire the restaurant identifier from the marker. The mobile electronic device also has a network interface configured to transmit the restaurant identifier to the server, and to receive the restaurant menu associated with the transmitted restaurant identifier. The mobile electronic device further includes a user interface to display the received restaurant menu associated with the restaurant identifier.

In accordance with another preferred embodiment the present invention provides a computer-implemented method of presenting a restaurant menu. The method includes acquiring a restaurant identifier on a mobile electronic device and then transmitting the acquired restaurant identifier to a server on which a restaurant menu is stored. The restaurant menu has a plurality of menu items and an image associated with at least one menu item. The restaurant menu is also associated with the restaurant identifier. The method further includes receiving the restaurant menu on the mobile electronic device upon the server receiving the transmitted restaurant identifier and displaying the restaurant menu on the mobile electronic device.

In accordance with yet another preferred embodiment the present invention provides a computer-implemented method of presenting a restaurant menu. The method includes storing a plurality of restaurant menus in a database. Each of the plurality of restaurant menus includes a plurality of menu items and an image associated with at least one menu item. The method further includes associating each of the plurality of restaurant menus with a respective restaurant identifier. Furthermore, the method includes receiving a particular restaurant identifier from a mobile electronic device and transmitting the restaurant menu associated with the received restaurant identifier to the mobile electronic device.

### BRIEF DESCRIPTION OF THE SEVERAL VIEWS OF THE DRAWINGS

The foregoing summary, as well as the following detailed description of the preferred embodiments of the invention, will be better understood when read in conjunction with the appended drawings. For the purpose of illustrating the invention there are shown in the drawings several aspects, but it should be understood that the invention is not limited to the precise arrangements and instrumentalities shown.

In the drawings:

FIG. 1 is a schematic of a restaurant menuing system in accordance with a preferred embodiment of the present invention;

FIG. 2 is a schematic of a server in accordance with the embodiment of FIG. 1;

FIG. 3 is a schematic of a marker in accordance with the embodiment of FIG. 1;

FIG. 4 is a schematic of a mobile electronic device in accordance with the embodiment of FIG. 1;

FIG. 5 is a flow chart of a method in accordance with another preferred embodiment of the present invention;

FIG. 6 is a flow chart of a method in accordance with yet another preferred embodiment of the present invention;

FIG. 7 is a flow chart of a method in accordance with an embodiment of the present invention;

FIG. 8A is a schematic of a restaurant menu in accordance with an embodiment of the present invention;

FIG. 8B is a schematic of a personalized menu in accordance with an embodiment of the present invention; and

FIG. 9 is a schematic of a computer applicable to the embodiments of the present invention.

### DETAILED DESCRIPTION OF THE INVENTION

Reference will now be made in detail to the preferred embodiments of the invention illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. Such directional terms used in conjunction with the following description of the drawings should not be construed to limit the scope of the invention in any manner not explicitly set forth. Additionally, the term “a,” as used in the specification, means “at least one.” The terminology includes the words above specifically mentioned, derivatives thereof, and words of similar import.

The term “restaurant,” is used throughout the specification for convenience and it should be understood that this term is not intended to be limiting. Thus, “restaurant” refers to an establishment at which prepared food may be purchased.

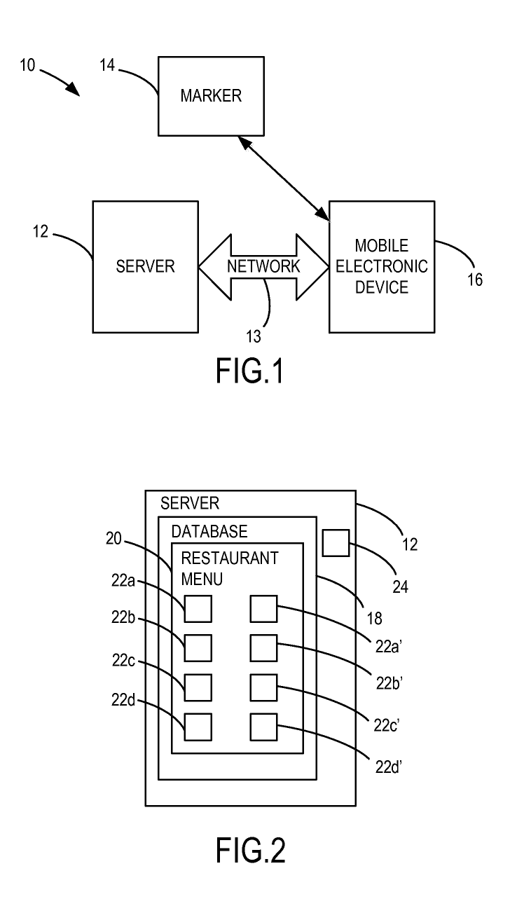

FIG. 1 illustrates a restaurant menuing system 10 in accordance with a preferred embodiment of the present invention. The restaurant menuing system 10 includes a server 12, a marker 14, and a mobile electronic device 16. The server communicates with the mobile electronic device through a network 13. The network may be for example the Internet, a cellular communication network such as a CDMA (“Code Division Multiple Access”) or GSM (“Global System for Mobile Communication”) network, or a similar electronic communication network. The mobile electronic device scans the marker in order to acquire information that is encoded in the marker. The mobile electronic device may read the marker for example, by scanning the marker using an optical technology such as a smart phone camera or a similar device.

FIG. 2 provides a schematic view of the server 12 shown in FIG. 1 in accordance with a preferred embodiment of the present invention. The server is a computing device that includes a database 18 that stores a restaurant menu 20. In an example of such a database, the database may be a system to manage the storage of electronic files such as an Oracle™ or a MySQL™ database. In certain embodiments the restaurant menu stored in the database may be an electronic file such as an HTML file which is suitable for display on a computer. In certain other embodiments the database may store multiple files or objects which can be assembled to generate an electronic version of a restaurant menu. The restaurant menu 20 includes a set of menu items 22a-22d each of which has a respective associated image 22a′-22d′. The server also includes a processor 24 configured to receive information (e.g., meta-data such as a rating) which may be associated with a menu item of the set of menu items 22a-22d.

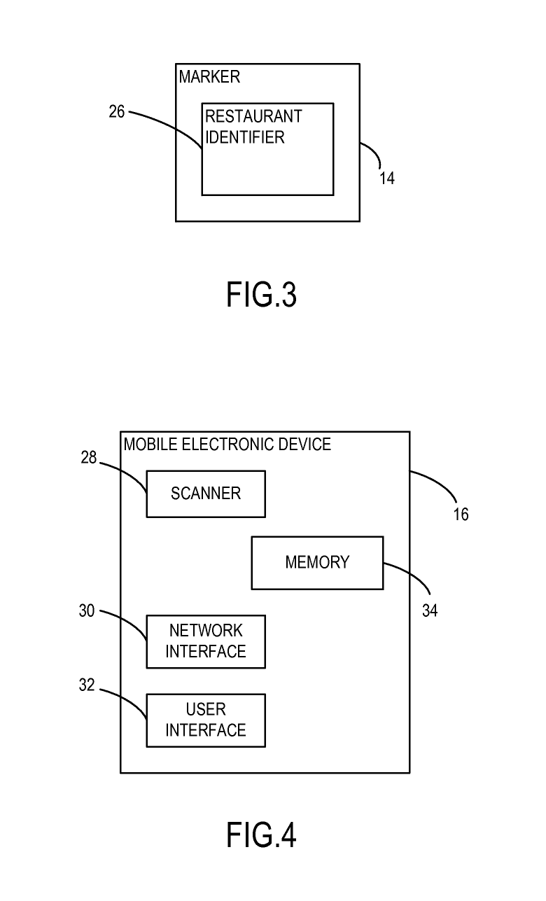

FIG. 3 provides a schematic view of the marker 14 shown in FIG. 1. In a preferred embodiment the marker is an object or tag that can be detected (e.g., by scanning or reading the marker) and analyzed by the mobile electronic device. The marker, having been detected by the mobile electronic device is decoded by the mobile electronic device so that information encoded in the marker can be acquired by the mobile electronic device. For example, the marker contains an encoded restaurant identifier 26 that is associated with a particular restaurant, that has an associated restaurant menu stored on the server. The restaurant menu includes a list of menu items that are available in the restaurant with which the marker is physically associated. The marker may e.g., be affixed to a physical menu in a restaurant, the marker may be on a sign in the restaurant, or the marker may be placed on a table tent in the restaurant. There are a number of technology choices available to implement the marker that are known in the art, as such a detailed description of such markers is not necessary for a complete understanding of the present invention. A key aspect of the marker is that it must be readable by a scanner that can extract the restaurant identifier from the marker. Appropriate technologies to implement a marker in accordance with the embodiments of the present disclosure include codes, such as a QR code, a bar code, and a UPC code.

A scanner operative to detect a marker that includes a QR (“Quick Response”) code and to acquire information (e.g., a restaurant identifier) from the QR code are known in the art and a further detailed description of their structure, function and operation is not necessary for a complete understanding of this particular aspect of the subject disclosure. However, typical QR code scanners applicable to the present invention are disclosed in U.S. Pat. No. 8,914,767, the entire disclosure of which is incorporated by reference herein for all purposes. A bar code reader scanner operative to detect a marker that includes a bar code and to acquire information (e.g., a restaurant identifier) from the bar code are also known in the art and a further detailed description of their structure, function and operation is not necessary for a complete understanding of this particular aspect of the subject disclosure. However, typical bar code readers applicable to the subject disclosure are disclosed in U.S. Pat. No. 4,418,276, the entire disclosure of which is incorporated by reference herein for all purposes. A UPC reader scanner operative to detect a marker that includes a UPC code and to acquire information (e.g., a restaurant identifier) from the UPC code are also known in the art and a further detailed description of their structure, function and operation is not necessary for a complete understanding of this particular aspect of the subject disclosure. However, typical UPC code readers applicable to the subject disclosure are disclosed in U.S. Pat. No. 4,075,461, the entire disclosure of which is incorporated by reference herein for all purposes.

FIG. 4 provides a schematic view of the mobile electronic device 16 shown in FIG. 1. Examples of mobile electronic devices in accordance with the present embodiment include a smart phone, a tablet computer, a personal digital assistant, a wearable computing device (e.g., Google Glasses™,) or similar devices. The mobile electronic device includes a scanner 28, a network interface 30, and a user interface 32. The scanner is configured to acquire a restaurant identifier that is stored in the marker by scanning the marker and decoding the information contained therein. The network interface is configured to transmit the restaurant identifier to the server and to receive a restaurant menu associated with the transmitted restaurant identifier. The user interface displays the restaurant menu associated with the restaurant identifier.

In accordance with another preferred embodiment the mobile electronic device 16 includes a memory 34 for storing information such as a user specific meal profile. A user specific meal profile contains information about a particular user (e.g., a restaurant patron) and their dietary preferences and/or dietary restrictions. Examples of dietary preferences and/or dietary restrictions include information such as, the particular user being a vegan or a vegetarian, has a gluten allergy, is on a low-carbohydrate diet, prefers spicy food, dislikes pasta, or any similar information about the user that may be useful in identifying aspects of menu items that would be attractive or appropriate for the user. In such embodiments, the server is configured to generate a personalized menu based on the user specific meal profile received from the mobile electronic device and the restaurant menu. The mobile electronic device is also configured to receive the personalized menu and display the personalized menu on the user interface.

In another aspect of the present invention, the database stores a coupon associated with the restaurant menu and the mobile electronic device retrieves the coupon for display on the user interface upon retrieving the restaurant menu. This display of the coupon can also be configured to occur on a limited basis e.g., only once upon initial access to the server, or randomly.

In another aspect of the present invention the server further includes a processor 24 configured to receive a rating of one of the plurality of menu items. A rating is an indication of preference which may be received by a user who has experienced a particular restaurant menu item. For example, a rating may be a “thumbs up” or “thumbs down” indicator received from a user or a number of stars rating. A rating may also be used to indicate a dietary preference. Additionally, the server may be configured to automatically modify the user specific meal profile based on a rating received from the mobile electronic device. In such embodiments the processor receives the user specific meal profile and stores the user specific meal profile in the database.

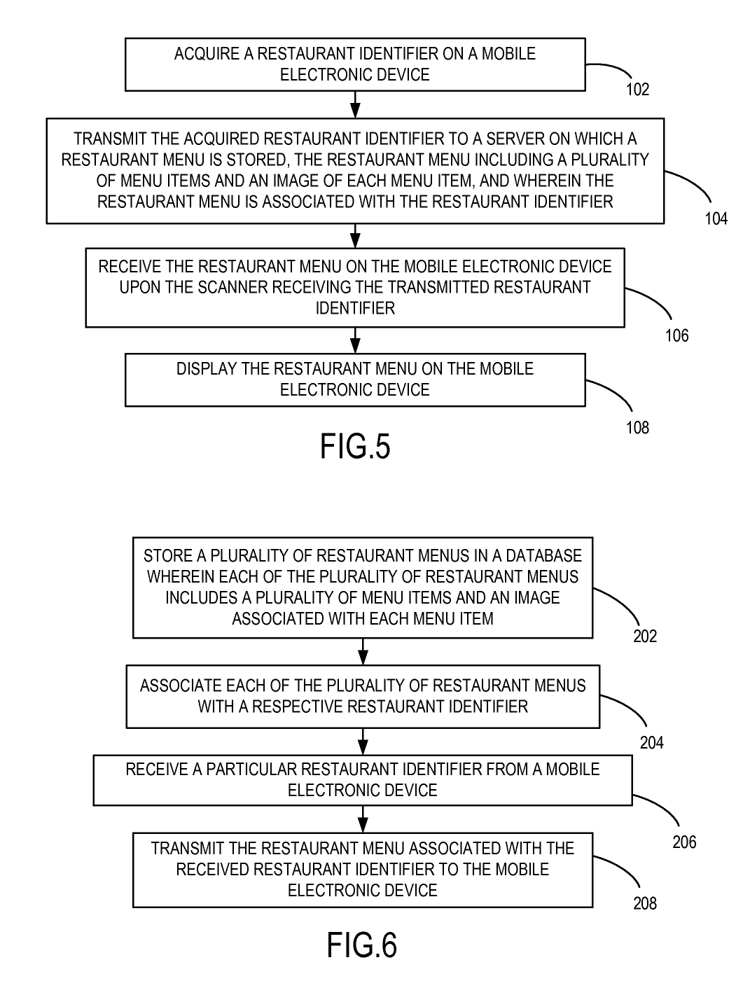

In accordance with another preferred embodiment, the present invention provides a computer-implemented method of presenting a restaurant menu, as illustrated in FIG. 5. In step 102, a restaurant identifier is acquired on a mobile electronic device. This may be accomplished for example, by scanning a marker (such as a QR Code, an RFID tag, a UPC code, or the like) on which the restaurant identifier is encoded. In step 104, the acquired restaurant identifier is transmitted to a server on which a restaurant menu is stored. This step may be performed by an application (“app”) that runs on the mobile electronic device where the app has been programmed to communicate with the server. In such an embodiment, the restaurant menu is stored on the server and includes a plurality of menu items and an image associated with at least one menu item. In order to implement such a method, one or more restaurant proprietors may send their restaurant menus to the server for storage in advance of placing the marker in their restaurant. This is done so that patrons of their restaurants can take advantage of this method of restaurant menuing when they encounter the marker. In sending their restaurant menus the restaurant proprietors include information and electronic image files that correspond to the plurality of menu items and associated images of each menu item. The server stores the plurality of menu items and associated images so that each restaurant menu is associated with its respective restaurant identifier.

In step 106, the restaurant menu is received on the mobile electronic device upon the server receiving the transmitted restaurant identifier. This may be accomplished, for example by the server sending the restaurant menu to the app running on the mobile electronic device in response to the server having received the restaurant identifier. In step 108, the restaurant menu is displayed on the mobile electronic device. The app can be programmed to display the restaurant menu on the mobile electronic device or to cause the restaurant menu to open in another program such as a web browser running on the mobile electronic device.

In certain embodiments of the invention, the method further includes storing a user specific meal profile on the mobile electronic device and generating a personalized menu based on the restaurant menu and the user specific meal profile. Such a personalized menu may include a subset of the plurality of menu items on the restaurant menu. The user specific meal profile can include user specific information and may be managed by an app that runs on the mobile electronic device. In particular, the user specific meal profile can include information about dietary restrictions and dietary preferences of a user associated with the mobile electronic device. The method illustrated in FIG. 5 may also include a step of transmitting a rating of a particular menu item to the server. The mobile app running on the mobile electronic device may provide input functionality (e.g., a button or a similar user interface feature) that allows a user to give a certain number of stars or a thumbs up or thumbs down to a particular menu item. The mobile app can then transfer such an input to the server.

In accordance with yet another preferred embodiment, the present invention provides a computer-implemented method of presenting a restaurant menu, as illustrated in FIG. 6. In step 202, a plurality of restaurant menus are stored in a database wherein each of the plurality of restaurant menus includes a plurality of menu items and an image associated with at least one menu item. The restaurant menus which include menu items and associated images may be uploaded to a server by their associated restaurant proprietors. The server stores the restaurant menus and associated information in the database.

In step 204, each of the plurality of restaurant menus are associated with a respective restaurant identifier. When the server receives each of the restaurant menus a restaurant identifier is stored and associated with a respective restaurant menu. In step 206, a particular restaurant identifier is acquired from a mobile electronic device. The restaurant identifier is then received at the server from the mobile device with a request for information regarding the restaurant menu with which the restaurant identifier is associated. This request may be made by a user of the mobile electronic device who wishes to receive restaurant menuing information on their mobile electronic device. In step 208, the restaurant menu associated with the restaurant identifier is transmitted to the mobile electronic device. This step is performed by the server accessing the requested restaurant menu from its database and sending the restaurant menu information to the mobile electronic device so that the restaurant menu is available for presentation to the user of the mobile electronic device.

In certain embodiments the present method further includes storing a coupon associated with the particular restaurant identifier in the database and transmitting the coupon to the mobile electronic device upon an initial receipt of the restaurant identifier from the mobile electronic device. The coupon may also be transmitted according to a schedule or randomly, depending on how the server is configured.

Certain embodiments of the present invention include storing a user specific meal profile in the database and generating a personalized menu based on the user specific meal profile and the restaurant menu. These methods also include transmitting the personalized menu to the mobile electronic device. Certain other embodiments provide for a method that includes receiving a rating of a particular menu item from the mobile electronic device. Such a method may also include modifying the user specific meal profile based on the received rating.

In accordance with another aspect of the present invention, a request for an additional image associated with a particular menu item is received by the server from a mobile electronic device. In response to the request server will perform a search for the additional image. Such a search request may be received when a particular mobile electronic device user wishes to view more images of a particular restaurant menu item. A mobile electronic device user may make such a request if a menu does not include an image is not associated with a particular menu item. For example, in response to receiving such a request the server may search in a database of additional images of restaurant menu items. Such a database of additional images of menu items may contain one or more images of a particular restaurant menu item. Certain additional images may show a restaurant menu item served in a certain manner (e.g., sauce on the side, well-done, with a fried egg on top, or some other variation of a particular restaurant menu item). In another aspect a search may be performed over a network (such as the Internet) to obtain images which are available from other locations which are similar to the particular restaurant menu item or similar in nomenclature to the particular restaurant menu item.

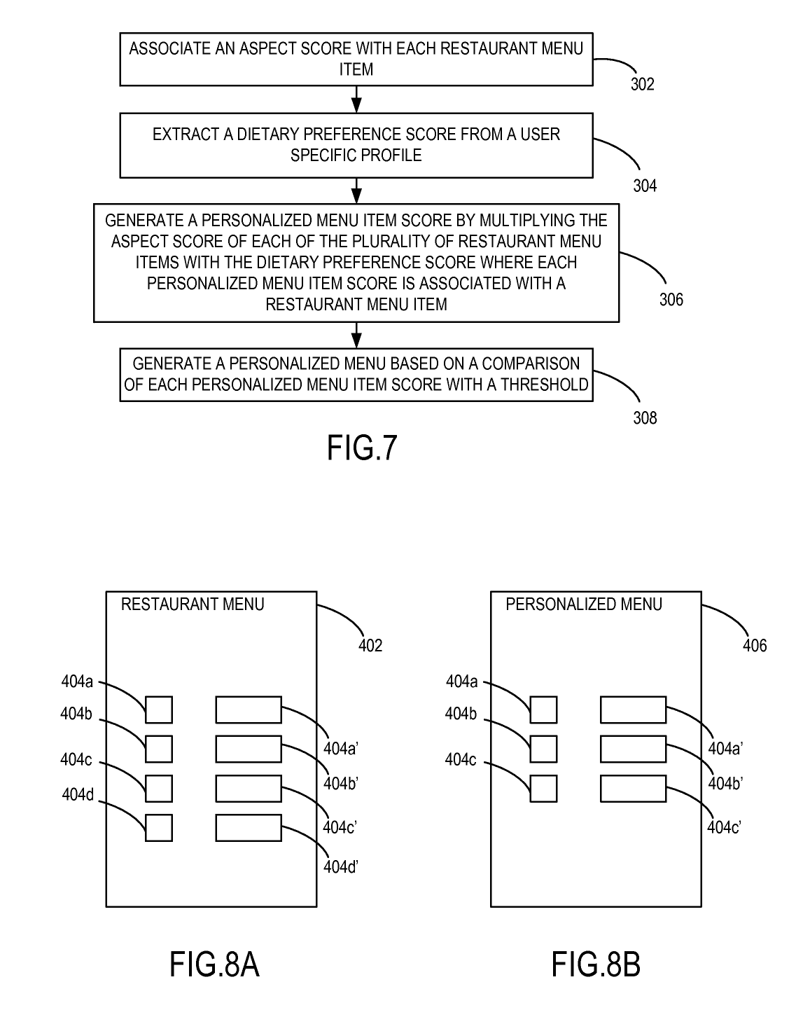

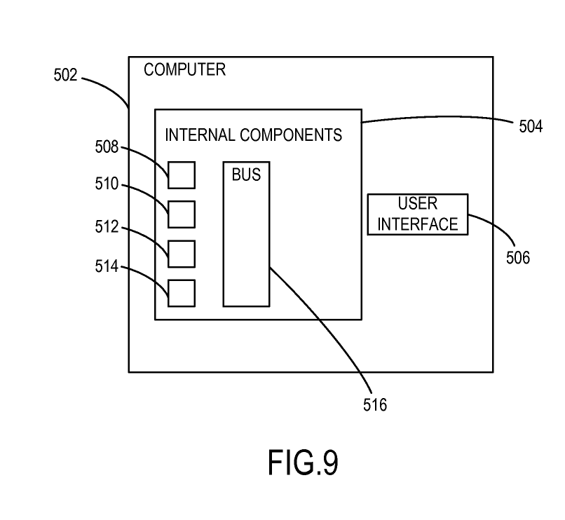

FIG. 7 illustrates the steps in a process that, when run on a computing device such as illustrated in FIG. 9, can generate a personalized menu based on the user specific meal profile as mentioned in certain embodiments of the present invention.

In step 302, an aspect score is associated with each restaurant menu item. An aspect score indicates a degree of an aspect of each restaurant menu item. For example, an aspect of a particular restaurant menu item may be spiciness. A dish that is very spicy can have an aspect score of 1 associated with the aspect of spiciness. A dish that contains meat can have an aspect score of 0 associated with the aspect of vegetarianism. In step 304, a dietary preference score is extracted from a user specific meal profile. An example of a dietary preference score is a 0 for spicy food which can indicate that a user's diet excludes spicy food. In step 306, a personalized menu item score is generated by multiplying the aspect score of each of the plurality of restaurant menu items with the dietary preference score, where each personalized menu item score is associated with a restaurant menu item. In step 308, each personalized menu item score is compared with a threshold. Based on the comparison a personalized menu is generated. For example, if the threshold is set to 0.75, only items with a personalized menu score above 0.75 would be included on the personalized menu. Items with a personalized menu score below 0.75 would not be listed on the personalized menu.

FIG. 8A illustrates a restaurant menu in accordance with another embodiment of the present invention. The restaurant menu 402 includes a plurality of restaurant menu items 404a-404d. Each of the restaurant menu items 404a-404d has an associated image 404a′-404d′. FIG. 8B illustrates a personalized menu 406. The personalized menu 406 includes a plurality of restaurant menu items 404a-404c, each of the plurality of restaurant menu items has an associated image 404a′-404c′. The personalized menu in FIG. 8B is generated based on the restaurant menu illustrated in FIG. 8A after a process such as the process illustrated in FIG. 7 is utilized. That is, based on a comparison a personalized menu score associated with each of the menu items 404a-40d to a threshold a determination whether each menu item 404a-404d should be listed on the personalized menu is made. In the example illustrated by FIGS. 8A and 8B, a determination that menu item 404d should not be listed on the personalized menu 406 is made. Accordingly, the personalized menu 406 is generated so that it lists only menu items 404a-404c of the restaurant menu 402. Such a process generates a menu that is uniquely suited to the particular restaurant patron associated with the user specific meal profile. By removing restaurant menus items which are inappropriate or undesirable to a restaurant patron the disclosed system generates a personalized menu. The personalized menu provides a simpler and more efficient restaurant experience for a restaurant patron.

FIG. 9 illustrates a schematic of internal and external hardware components of computer 502 in accordance with an embodiment of the present disclosure. Such a computer is suitable to implement the server 12 or the mobile electronic device 16 shown in FIG. 1. Computer 502 includes internal components 504 a user interface 506. Internal components 504 include one or more processors 508, one or more computer-readable RAMs 510 (which may be managed by a database which stores data on and reads data from the RAMs), a network interface system 512, and one or more computer-readable tangible storage devices 514. The internal components communicate with each other and with other components of the computer system over one or more buses 516. The processors 508 in conjunction with the computer-readable RAMs 510 and the computer readable tangible storage devices 514 are operable to run operating system software and application software which controls the functioning of the computer 502.

Various steps included in the processes such as those illustrated in FIGS. 5-7 may be performed by a software application or by software applications running on one or both of a server and a mobile electronic device implemented according to the schematic shown in FIG. 8

It will be appreciated by those skilled in the art that changes could be made to the various embodiments described above without departing from the broad inventive concept thereof. It is to be understood, therefore, that the present invention is not limited to the particular embodiments disclosed, but it is intended to cover modifications within the spirit and scope of the present invention as defined by the appended claims.

I/we claim:

1. A restaurant menuing system comprising:
a server that includes a database having a restaurant menu that includes a plurality of menu items and an image associated with at least one of the plurality of menu items;
a marker having a restaurant identifier associated with the restaurant menu; and
a mobile electronic device that includes:
a scanner configured to acquire the restaurant identifier from the marker,
a network interface configured to transmit the restaurant identifier to the server and receive the restaurant menu associated with the transmitted restaurant identifier; and
a user interface to display the received restaurant menu associated with the restaurant identifier.

2. The restaurant menuing system of claim 1, wherein the mobile electronic device further includes a memory to store a user specific meal profile, and wherein the server is configured to generate a personalized menu based on the user specific meal profile received from the mobile electronic device and the restaurant menu.

3. The restaurant menuing system of claim 2, wherein the mobile electronic device is configured to receive the personalized menu and display the personalized menu on the user interface.

4. The restaurant menuing system of claim 1, wherein the database further stores a coupon associated with the restaurant menu and the mobile electronic device retrieves the coupon for display on user interface upon retrieving the restaurant menu.

5. The restaurant menuing system of claim 1, wherein the server further includes a processor configured to receive a rating of one of the plurality of menu items.

6. The restaurant menuing system of claim 2, wherein the server further includes a processor for receiving the user specific meal profile and for storing the user specific meal profile in the database.

7. The restaurant menuing system of claim 6, wherein the server is further configured to automatically modify the user specific meal profile based on a rating received from the mobile electronic device.

8. The restaurant menuing system of claim 1, wherein the marker is a QR code, a bar code, or a UPC code.

9. The restaurant menuing system of claim 2, wherein the user specific meal profile includes dietary restriction information.

10. A computer-implemented method of presenting a restaurant menu comprising:
acquiring a restaurant identifier on a mobile electronic device;
transmitting the acquired restaurant identifier to a server on which a restaurant menu is stored, the restaurant menu including a plurality of menu items and an image associated with at least one of the plurality of menu items, and wherein the restaurant menu is associated with the restaurant identifier;
receiving the restaurant menu on the mobile electronic device upon the server receiving the transmitted restaurant identifier; and
displaying the restaurant menu on the mobile electronic device.

11. The computer-implemented method of claim 10, further comprising:
storing a user specific meal profile on the mobile electronic device; and
generating a personalized menu based on the restaurant menu and the user specific meal profile, wherein the personalized menu is a subset of the plurality of menu items.

12. The computer-implemented method of claim 10, further comprising transmitting a rating of a particular menu item to the server.

13. The computer-implemented method of claim 10, wherein acquiring a restaurant identification includes scanning a QR code, a bar code, or a UPC code.

14. A computer-implemented method of presenting a restaurant menu comprising:
storing a plurality of restaurant menus in a database wherein each of the plurality of restaurant menus includes a plurality of menu items and an image associated with at least one of the plurality of menu items;
associating each of the plurality of restaurant menus with a respective restaurant identifier;
receiving a particular restaurant identifier from a mobile electronic device; and
transmitting the restaurant menu associated with the received restaurant identifier to the mobile electronic device.

15. The computer-implemented method of claim 14, further comprising storing a coupon associated with the particular restaurant identifier in the database and transmitting the coupon to the mobile electronic device upon an initial receipt of the restaurant identifier from the mobile electronic device.

16. The computer-implemented method of claim 14, further comprising receiving a request from the mobile electronic device for an additional image associated with a particular menu item and performing a search for the additional image.

17. The computer-implemented method of claim 14, further comprising:
storing a user specific meal profile in the database; and
generating a personalized menu based on the user specific meal profile and the restaurant menu.

18. The computer-implemented method of claim 17, further comprising transmitting the personalized menu to the mobile electronic device.

19. The computer-implemented method of claim 18, further comprising receiving a rating of a particular menu item from the mobile electronic device.

20. The computer-implemented method of claim 19, further comprising modifying the user specific meal profile based on the received rating.
